(19) United States
(12) Patent Application Publication
(10) Pub. No.: US 2021/0407314 A1
(43) Pub. Date: Dec. 30, 2021

(54) SYSTEMS AND METHODS FOR PILOT TRAINING VIA STREAMING AVIONIC SIMULATION TO CLIENT DEVICE

(71) Applicant: Honeywell International Inc., Morris Plains, NJ (US)

(72) Inventors: Mahesh SIVARATRI, Bangalore (IN); Raghu SHAMASUNDAR, Bangalore (IN); Mythili KAMATH, Bangalore (IN); Charles DAIRMAN, Bangalore (IN); Srihari JAYATHIRTHA, Bangalore (IN)

(21) Appl. No.: 16/911,720

(22) Filed: Jun. 25, 2020

(51) Int. Cl. G09B 9/24; G09B 9/30; G09B 9/26; G09B 19/16

(52) U.S. Cl. CPC G09B 9/24; G09B 19/165; G09B 9/26; G09B 9/304

(57) ABSTRACT

Disclosed are systems, methods, and non-transitory computer-readable medium for providing data for flight simulation, or performing flight simulation using data provided by a remote server system. In some embodiments, a method for streaming avionic simulation may include: receiving, from a user device, a request for flight management service functions by a user; determining the flight management service functions registered to the user based on the request; determining a device setup configuration associated with the user; selecting one or more user devices based on the device setup configuration; receiving streaming data corresponding to a simulation of the flight management service functions; and transmitting the streaming data corresponding to the flight management service functions to one or more user devices, wherein the streaming data provides the simulation of the flight management service functions.

### TECHNICAL FIELD

Various embodiments of the present disclosure relate generally to flight simulation training for aircraft operations and, more particularly, to systems and methods for providing data to client devices for flight simulation, and performing flight simulations on client devices using data provided by a remote server system

### BACKGROUND

In order to conduct flight missions safely and efficiently (or effectively), pilots require adequate training in operating aircraft. Insufficient training may result in aviation incidents. Additionally, flight management systems and other aircraft technologies evolve over time to provide new features that improve safety and efficiency. Pilots who are inadequately trained on recent technologies may be unable to reap the benefits of such technological advancements.

Therefore, there is a need for systems and methods to provide for effective flight simulation, for purposes of training pilots in operating aircraft, on easily accessible computing devices. There is also a need for flight simulations executed on such computing devices to utilize server-hosted resources in a way that does not impair the effectiveness of the flight simulation for training purposes.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF DISCLOSURE

According to certain aspects of the disclosure, systems and methods are disclosed providing data to client devices for flight simulation, and performing flight simulation using data obtained provided by a remote server system.

In one embodiment, a computer-implemented method is disclosed for streaming avionic simulation. The computer-implemented method may comprise: receiving, from an user device, a request for flight management service functions by a user; determining the flight management service functions registered to the user based on the request; determining a device setup configuration associated with the user; selecting one or more user device based on the device setup configuration; receiving streaming data corresponding to a simulation of the flight management service functions; and transmitting the streaming data corresponding to the flight management service functions to one or more user devices, wherein the streaming data provides the simulation of the flight management service functions.

In accordance with another embodiment, a computer-implemented system is disclosed for streaming avionic simulation. The computer-implemented system may comprise: a memory having processor-readable instructions stored therein; and at least one processor configured to access the memory and execute the processor-readable instructions, which when executed by the processor configures the processor to perform functions for: receive, from an user device, a request for flight management service functions by a user; determine the flight management service functions registered to the user based on the request; determine a device setup configuration associated with the user; select one or more user device based on the device setup configuration; receive streaming data corresponding to a simulation of the flight management service functions; and transmit the streaming data corresponding to the flight management service functions to one or more user devices, wherein the streaming data provides the simulation of the flight management service functions.

In accordance with another embodiment, a non-transitory computer-readable medium is disclosed for streaming avionic simulation. The non-transitory computer-readable medium may comprise instructions for: receiving, from an user device, a request for flight management service functions by a user; determining the flight management service functions registered to the user based on the request; determining a device setup configuration associated with the user; selecting one or more user device based on the device setup configuration; receiving streaming data corresponding to a simulation of the flight management service functions; and transmitting the streaming data corresponding to the flight management service functions to one or more user devices, wherein the streaming data provides the simulation of the flight management service functions.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a system for streaming flight simulation to client devices, according to one aspect of the present disclosure.

FIG. 2 depicts an exemplary block diagram of the system depicted in FIG. 1, according to one aspect of the present disclosure.

FIG. 3 depicts an exemplary implementation of the flight simulation streaming system, according to one aspect of the present disclosure.

FIG. 4 depicts a flowchart of the exemplary method for streaming flight simulation to client devices, according to one aspect of the present disclosure.

FIG. 5 depicts an exemplary computer device or system, in which embodiments of the present disclosure, or portions thereof, may be implemented

### DETAILED DESCRIPTION OF EMBODIMENTS

Due to the increase in demand for new pilots, there exists a need for a training solution that provides efficiency for both instructor and trainee, and flexibility for rearranging display windows on multiple display devices. The present disclosure describes a solution that employs cloud based streaming techniques to enhance the pilot training experience. For example, the present disclosure may allow a trainee to configure and arrange avionics display windows and control panels onto multiple display devices, thereby reducing inefficiencies related to cluttered displays. As will be discussed in more detail below, the functions of a flight management system (FMS) used for flight simulation may be hosted on a server system in a cloud. The server system in the cloud may also store a client device configuration indicating the types of avionics displays to be presented on one or more client devices. Accordingly, the FMS may execute avionics simulations and transmit streaming packets for avionics related display windows and panels to each of the client devices used for training.

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

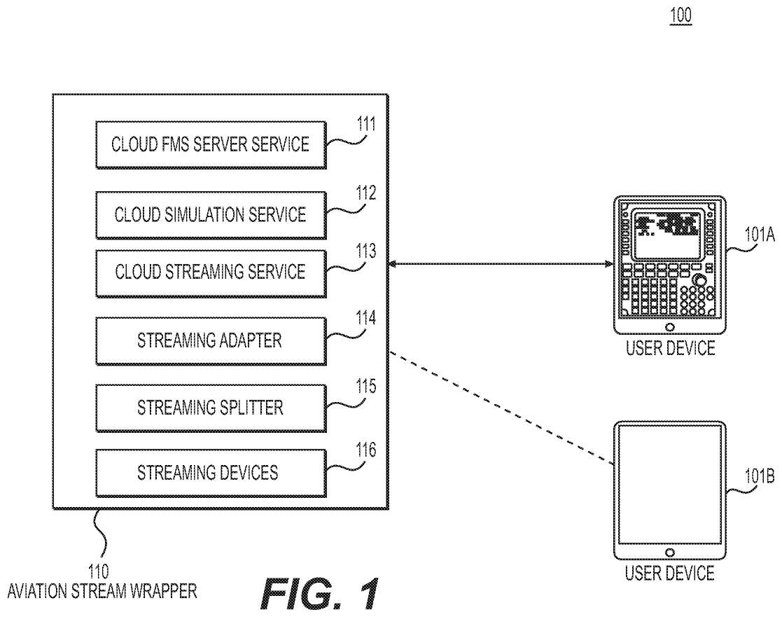

Referring now to the appended drawings, FIG. 1 depicts a system 100 for streaming flight simulation to client devices, according to one aspect of the present disclosure. The system 100 may include user devices 101A and optionally user devices 101B, and the aviation stream wrapper 110. The aviation stream wrapper 110 may include cloud FMS server service module 111, cloud simulation service module 112, cloud streaming service module 113, streaming adapter 114, streaming splitter 115, and streaming devices 116. The user devices 101A and 101B may be any combination of a tablet, smartphone, laptop, desktop, personal digital assistant, e-reader, or any other personal devices accessible by the user. The aviation stream wrapper 110 may include other software as a service (SaaS) systems, and the aviation stream wrapper 110 may also be a cloud-based platform that provides services to any user who has authorized access to the aviation stream wrapper 110.

The cloud FMS server service module 111 may be initiated based on a user configuration and platform when a user logs into the cloud streaming service. One or more functionalities may be registered to the cloud FMS server service module 111 and executed by the module 111 when requested by the user. The one or more functionalities registered may include at least a flight planning function, a performance function, a navigation function, and a datalink function. The flight planning function may enable the user to string a flight plan and modify the flight plan, and to be able visualize the plan on the display screen of the device. The performance function may enable a prediction capability, which may provide the predicted time and fuel information over the flight plan. The navigation function may provide guidance and navigation module of an aircraft. The datalink function may provide digital communication between the air crew and ground dispatcher.

The cloud simulation service module 112 may operate in combination with the cloud FMS server service module 111 to provide simulation services to the user devices 101A and 101B. Cloud simulation may include collection of various flight deck displays as well as flight deck panels interfaced and/or driven with cloud avionics services. The cloud simulation service module 112 may provide simulation to the full versions of avionics executed by cloud FMS server service module 111 to ensure simulations may be transmitted downstream to user devices 101A and 101B.

The cloud streaming service module 113 may determine the display windows and simulation and control panel windows available to the user based on the aircraft configuration selected by the user. For example, the user may select a certain aircraft by model or type that the user would like to receive training on and the cloud streaming service module 113 may determine the displays available for the selected aircraft (i.e. Multi-Function Control and Display Unit (MCDU), Navigation Display (ND), Primary Flight Display (PFD), Vertical Situation Display (VSD)) and the simulation and control panels available for the selected aircraft (i.e. Mode Control Panel (MCP), Electronic Flight Instrumentation System Control Panel (ECP)) to ensure that the user receives training based on simulation of the appropriate aircraft. The cloud streaming service module 113 may also periodically build streaming packets for all the display windows and simulation panels and place the streaming packets in a priority queue for transmission to one or more user devices.

The streaming adapter 114 may be a hardware or software module that routes the streaming packets received from the cloud streaming service 113 to the appropriate streaming devices according to a configuration file. The adapter 114 may also filter out any streaming windows or panels that a user is not subscribed to or registered for. For example, if a user is registered for MCDU but not ND, the streaming adapter 114 may filter out the streaming packets related to ND such that the ND window is not shown to the user. The streaming adapter 114 may also be configured to prioritize one or more user devices so that those devices may be refreshed at a faster rate. For example, the streaming adapter 114 may prioritize the streaming packets destined for high priority user devices so that the high priority user devices are refreshed with lowest possible latency.

The streaming splitter 115 may be a hardware or software module that may function to split the streaming packets to various devices. As illustrated in FIG. 1, user device 101B may be an optional device under the control of an instructor, and user device 101A may be under the control of a trainee. In one embodiment, training sessions are led by one or more instructors and the instructors may have control on various control panels and display windows to create flight diversions and/or deviations from pre-planned flight profile to simulate unplanned external environment. In this embodiment, the streaming splitter 115 may split the control panels and display windows between trainee and instructor so that the trainee may train on how to tackle unplanned situations. The splitter 115 may transmit the streaming packets for the appropriate control panels and display windows to the appropriate instructor and trainee user devices.

Streaming devices 116 may correspond to user devices 101A and 101B and may include the user devices 101A and 101B or may be in addition to user devices 101A and 101B. The streaming devices 116 may be tablet devices or any other personal device (i.e., smartphone, PDA, laptop, desktop) that is capable of executing user application and receive data from cloud streaming service module 113. The devices 116 may be used by the trainee to learn flight management functions of an aircraft running on the cloud FMS server service 111 or used by instructors via the streaming adapter 114.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, two or more devices shown in FIG. 1 (e.g., streaming devices 116 and user device 101A and 101B) may be implemented within a single device. Additionally, or alternatively, a set of devices (e.g., one or more devices) of environment 100 may perform one or more functions described as being performed by another set of devices of environment 100.

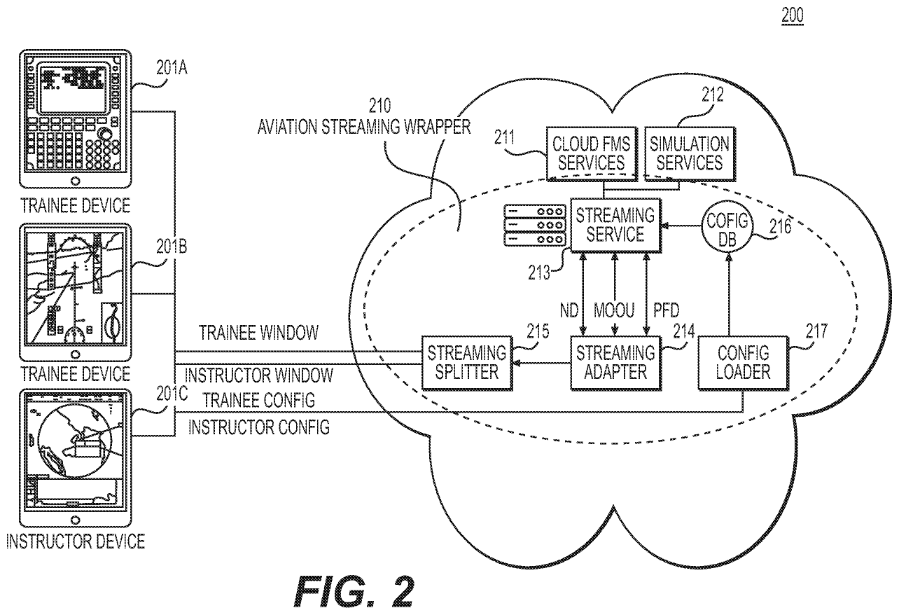

FIG. 2 illustrates an exemplarily implementation of the system 100 of FIG. 1, according to one aspect of the present disclosure. In FIG. 2, diagram 200 may include the aviation streaming wrapper 210, cloud FMS services module 211, simulation services module 212, streaming service module 213, streaming adapter 214, streaming splitter 215, configuration database 216, configuration loader 217, and user devices 201A-201C. The user devices 201A-201C may correspond to user devices 101A and 101B as depicted in FIG. 1. In the embodiment depicted in diagram 200, devices 201A and 201B may be trainee devices, and device 201C may be an instructor device. The aviation streaming wrapper 210, cloud FMS services module 211, simulation services module 212, streaming service module 213, streaming adapter 214, and streaming splitter 215 may correspond to the aviation stream wrapper 110, cloud FMS server service module 111, cloud simulation service module 112, cloud streaming service module 113, streaming adapter 114, and streaming splitter 115 and may have similar functions. The configuration database 216 may store data related to preferences and device information of the user. For example, the database may store a streaming window device setup configuration that specifies which display window or panel may be streamed to each device. Each user of the cloud streaming system may have an individual setup configuration, so the user may log in to the system by inputting their login credentials (e.g. username and password) and may be presented with a user interface to complete the setup configuration. The setup configuration may include a list of allowed display windows or control panels that the user is registered or subscribed to, and may enable the user to select or deselect display windows or control panels to update the configuration. A user or trainee may register for training of a particular display unit instead of the entire avionics suite. For example, if a user registers for MCDU page training then only the MCDU window will be included in the streaming packets being delivered to the user. The configuration database 216 may also enable instructors to store device information and preference related to training instructions. For example, an instructor may store a configuration on display windows or panels utilized to create scenarios for trainee to execute. The configuration database 216 may also allow the user to assign different priorities to the registered avionics displays windows and/or control panels and the one or more user devices. The user may indicate that certain display windows and/or control panels may need to be refreshed at a faster rate than the other display windows and/or control panels and therefore have a higher priority. The configuration loader 217 may work in combination with the configuration database 216 to store data into the database and execute the stored data from the database.

The number and arrangement of modules, devices, and networks shown in FIG. 2 are provided as an example. In practice, there may be additional modules and devices, fewer modules, devices and/or networks, different modules, devices and/or networks, or differently arranged modules, devices and/or networks than those shown in FIG. 2. Furthermore, two or more devices included in diagram 200 of FIG. 2 may be implemented within a single device, or a single device in the environment 200 of FIG. 2 may be implemented as multiple, distributed devices. Additionally, or alternatively, a set of devices (e.g., one or more devices) of environment 200 may perform one or more functions described as being performed by another set of devices of environment 200.

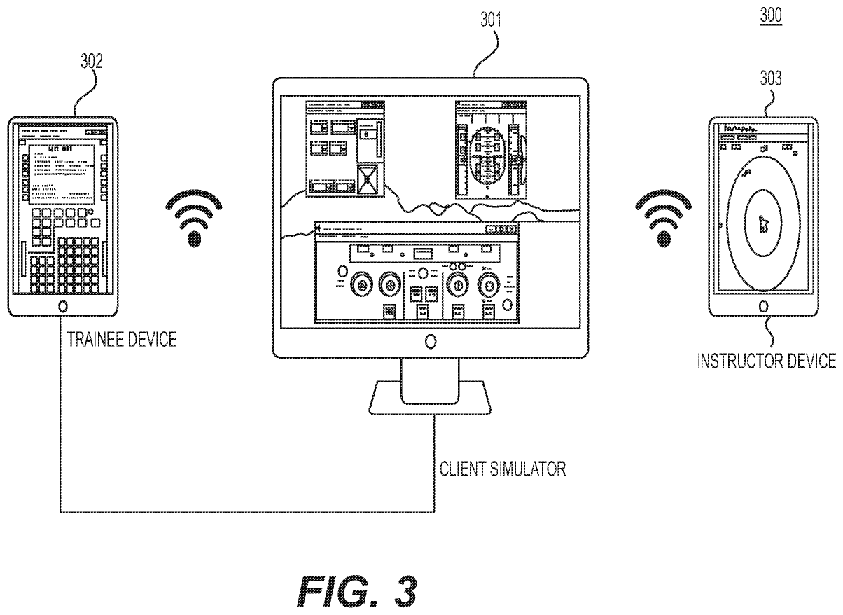

FIG. 3 depicts an exemplary implementation environment 300 of the flight simulation streaming system, according to one aspect of the present disclosure. Environment 300 may represent an embodiment of the current disclosure to provide cloud based streaming technique to enhance training experience. The embodiment allows user or trainee to configure or arrange avionics display windows and control panels onto multiple display devices for instructing and training. Environment 300 may include a client simulator 301, a trainee device 302, and an instructor device 303. The user/trainee may setup a device and display configuration preference that is stored in a configuration database. Based on the configuration the display windows and/or control panels may be streamed onto appropriate display device. For example, as depicted in FIG. 3, the trainee may have configured the MCDU/MFD display to be streaming on trainee device 302 which may be a tablet device and the PFD display and MCP control panel on client simulator 301 which may be a laptop or desktop device. The user may also arrange all display windows and/or control panels on to one device, for example in situations where the user only has one device available, or would only prefer to use one devoice. An instructor may have a separate configuration preference and configure the Vertical Situation Display (VSD) to display on the instructor device 303. The client simulator 301, trainee device 302, and instructor device 303 may receive the streaming data packets related to the display windows and control panels via a connection to the aviation streaming wrapper depicted in FIG. 1 and FIG. 2. The connection may be any one or wired or wireless connection, wireless connection may be any one or satellite, cellular, 4G, 5G, WIFI, or any other wireless connection known in the art.

Although FIG. 3 shows exemplary components, in some implementations, environment 300 may include additional components (e.g. user devices), fewer components (e.g. user devices), different components (e.g. user devices), or differently arranged components (e.g. user devices) than those depicted in FIG. 3.

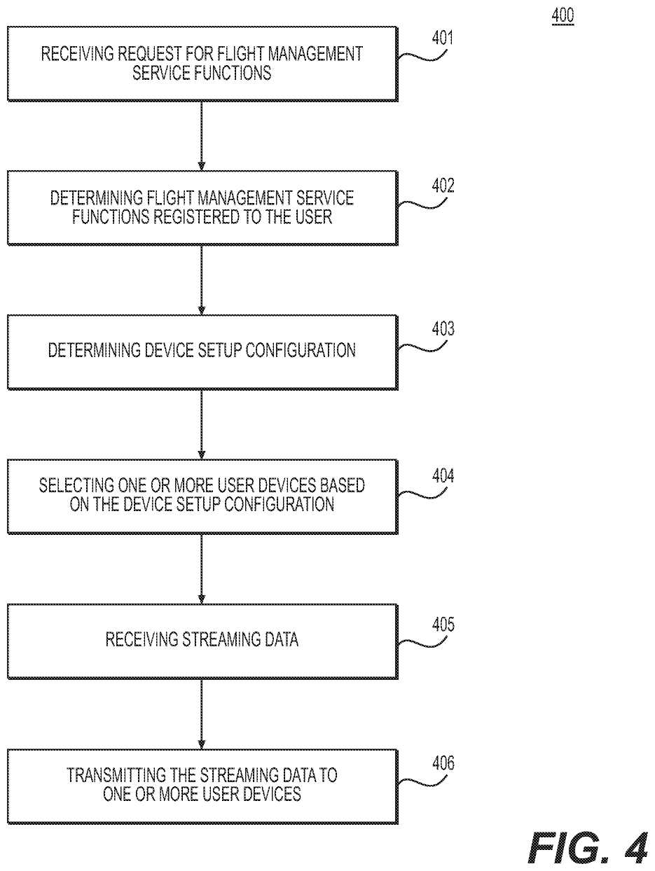

FIG. 4 depicts a flowchart 400 of the exemplary method for streaming flight simulation to client devices, according to one aspect of the present disclosure. The exemplary method may begin at step 401 when a request for flight management service functions may be received by the aviation streaming wrapper. The request for the flight management service functions may be submitted by a trainee or an instructor. The request may be submitted using any one of a plurality of user devices under operation by the trainee or the instructor. After receiving the request, the aviation streaming wrapper may determine which flight management service functions are registered to the user at step 402. For example, the cloud FMS services may be able to execute all avionics displays related to supported aircrafts, however a user may not need to access all avionics displays. A user may only need to train on a certain selections of avionics displays due to a plurality of reasons (e.g. cost, certification requirements) and therefore a user may only register for avionics displays as needed. Once registered displays are determined, the method may proceed to step 403 where the aviation streaming wrapper may access a device configuration file setup by the user. The device configuration file may store setup configuration related to devices being used by the user and which avionics displays to be presented on those devices. For example, in one embodiment, a user may only have one device and therefore all avionics displays will be presented on the one device. In another embodiment, a user may have multiple user devices and may configure specific avionics displays to specific user devices. The aviation streaming wrapper may determine the specific device configuration at step 403 and at step 404 the aviation streaming wrapper may select one or more user devices based on the device setup configuration to transmit the registered avionic displays. At step 405, the transmitted registered avionic displays may be received by a streaming adapter. The streaming adapter may be a module within the avionic streaming wrapper and may operate to direct the streaming data of the avionic displays to the appropriate user device as determined by the avionic streaming wrapper at steps 403 and 404. At step 406, the streaming adapter may route the streaming data of the registered avionic displays to the selected user devices. In one embodiment, a training session may be led by an instructor, and the instructor may desire to have control on certain control panels and display windows to create flight diversions and deviation from pre-planned flight profile and simulate unplanned external environments. The streaming adapter may work in combination with a streaming splitter to split the streaming data of the registered avionic displays and transmit the streaming data to one or more user devices under operation of an instructor. In another embodiment, the user may assign different priorities to the registered avionics displays windows and/or control panels and the one or more user devices. The priorities may be stored in the user configuration database as depicted in FIG. 2. The user may indicate that certain display windows and/or control panels may need to be refreshed at a faster rate than the other display windows and/or control panels. In this embodiment, the streaming adapter will then prioritize those streaming packets so that higher priority displays are refreshed without any latency.

Although FIG. 4 shows examples process for streaming flight simulation to client devices, in some implementations, flowchart 400 may have additional steps, fewer steps, different steps, or differently arranged blocks than those depicted in FIG. 4. Additionally, or alternatively, two or more of the blocks of the flowchart 400 may be performed in parallel.

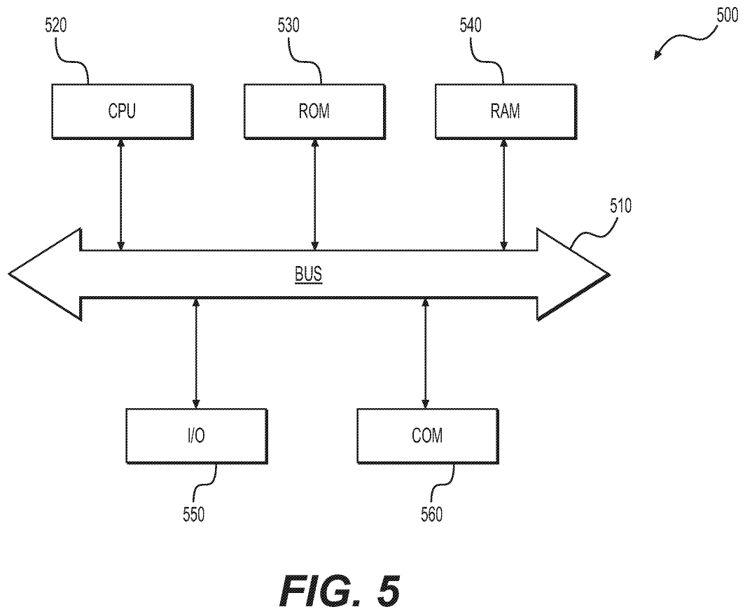

FIG. 5 depicts a high-level functional block diagram of an exemplary computer device or system, in which embodiments of the present disclosure, or portions thereof, may be implemented, e.g., as computer-readable code. Additionally, each of the exemplary computer servers, databases, user interfaces, modules, and methods described above with respect to FIGS. 1-4 can be implemented in device 500 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-4.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

Various embodiments of the present disclosure, as described above in the examples of FIGS. 1-4, may be implemented using device 500. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 5, device 500 may include a central processing unit (CPU) 520. CPU 520 may be any type of processor device including, for example, any type of special purpose or a general-purpose microprocessor device. As will be appreciated by persons skilled in the relevant art, CPU 520 also may be a single processor in a multi-core/multiprocessor system, such system operating alone, or in a cluster of computing devices operating in a cluster or server farm. CPU 520 may be connected to a data communication infrastructure 510, for example, a bus, message queue, network, or multi-core message-passing scheme.

Device 500 also may include a main memory 540, for example, random access memory (RAM), and also may include a secondary memory 530. Secondary memory 530, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 530 may include other similar means for allowing computer programs or other instructions to be loaded into device 500. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 500.

Device 500 also may include a communications interface (“COM”) 560. Communications interface 560 allows software and data to be transferred between device 500 and external devices. Communications interface 560 may include a modem, a network interface (such as an Ethernet card), a communications port, a PCMCIA slot and card, or the like. Software and data transferred via communications interface 560 may be in the form of signals, which may be electronic, electromagnetic, optical, or other signals capable of being received by communications interface 560. These signals may be provided to communications interface 560 via a communications path of device 500, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 500 also may include input and output ports 550 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It is intended that the specification and examples be considered as exemplary only, with a true scope and spirit of the disclosure being indicated by the following claims.

What is claimed is:

1. A computer-implemented method for streaming avionic simulation, the method comprising:
receiving, from a user device, a request for flight management service functions by a user;
determining the flight management service functions registered to the user based on the request;
determining a device setup configuration associated with the user;
selecting one or more user devices based on the device setup configuration;
receiving streaming data corresponding to a simulation of the flight management service functions; and
transmitting the streaming data corresponding to the flight management service functions to one or more user devices, wherein the streaming data provides the simulation of the flight management service functions.

2. The computer-implemented method of claim 1, wherein the flight management service functions include at least one of a flight planning function, a performance function, a navigation function, and a datalink function.

3. The computer-implemented method of claim 1, wherein device setup configuration includes placement of display windows or flight deck panels of the flight management service functions registered to the user on the one or more user devices.

4. The computer-implemented method of claim 1, wherein the one or more user devices include a trainee device and an instructor device.

5. The computer-implemented method of claim 4, further comprising:
receiving, from the instructor device, instructions to create deviations from a planned flight profile; and
transmitting and presenting simulations of the deviations from planned flight profile to the trainee device.

6. The computer-implemented method of claim 1, further comprising:
assigning a priority to the streaming data corresponding to a simulation of the flight management service functions; and
transmitting the streaming data corresponding to the flight management service functions to one or more user devices based on the assigned priority.

7. The computer-implemented method of claim 1, further comprising:
receiving, from the one or more user devices, a request to register for flight management service functions.

8. A computer-implemented system for streaming avionic simulation, the computer-implemented system comprising:
a memory having processor-readable instructions stored therein; and
at least one processor configured to access the memory and execute the processor-readable instructions, which when executed by the processor configures the processor to perform functions for:
receive, from a user device, a request for flight management service functions by a user;
determine the flight management service functions registered to the user based on the request;
determine a device setup configuration associated with the user;
select one or more user devices based on the device setup configuration;
receive streaming data corresponding to a simulation of the flight management service functions; and
transmit the streaming data corresponding to the flight management service functions to one or more user devices, wherein the streaming data provides the simulation of the flight management service functions.

9. The computer-implemented system of claim 8, wherein the flight management service functions include at least one of a flight planning function, a performance function, a navigation function, and a datalink function.

10. The computer-implemented system of claim 8, wherein the device setup configuration includes placement of display windows of the flight management service functions registered to the user on the one or more user devices.

11. The computer-implemented system of claim 8, wherein the one or more user devices include a trainee device and an instructor device.

12. The computer-implemented system of claim 11, further comprising:
receive, from the instructor device, instructions to create deviations from a planned flight profile; and
transmit and present a simulation of the deviations from the planned flight profile to the trainee device.

13. The computer-implemented system of claim 8, further comprising:
assign a priority to the streaming data corresponding to a simulation of the flight management service functions; and
transmit the streaming data corresponding to the flight management service functions to one or more user devices based on the assigned priority.

14. The computer-implemented system of claim 8, further comprising:
receive, from the one or more user devices, a request to register for flight management service functions.

15. A non-transitory computer-readable medium containing instructions for streaming avionic simulation, comprising:
receiving, from a user device, a request for flight management service functions by a user;
determining the flight management service functions registered to the user based on the request;
determining a device setup configuration associated with the user;
selecting one or more user devices based on the device setup configuration;
receiving streaming data corresponding to a simulation of the flight management service functions; and
transmitting the streaming data corresponding to the flight management service functions to one or more user devices, wherein the streaming data provides the simulation of the flight management service functions.

16. The non-transitory computer-readable medium of claim 15, wherein the flight management service functions include at least one of a flight planning function, a performance function, a navigation function, and a datalink function.

17. The non-transitory computer-readable medium of claim 15, wherein device setup configuration includes placement of display windows of the flight management service functions registered to the user on the one or more user devices.

18. The non-transitory computer-readable medium of claim 15, wherein the one or more user devices include a trainee device and an instructor device.

19. The non-transitory computer-readable medium of claim 18, further comprising:
receiving, from the instructor device, instructions to create deviations from pre-planned flight profile; and
transmitting the deviations from pre-planned flight profile to the trainee device.

20. The non-transitory computer-readable medium of claim 15, further comprising:
assigning a priority to the streaming data corresponding to a simulation of the flight management service functions; and
transmitting the streaming data corresponding to the flight management service functions to one or more user devices based on the assigned priority.
